(19) United States
(12) Patent Application Publication
(10) Pub. No.: US 2026/0220167 A1
(43) Pub. Date: Jul. 30, 2026

(54) AI-BASED SYSTEM AND METHOD FOR AUTOMATICALLY ORCHESTRATING DEVELOPMENT OPERATION TASKS WITHIN DYNAMIC COMPUTING ENVIRONMENTS

(71) Applicant: xFabric Security Inc, Redmond, WA (US)

(72) Inventors: S M Mahbub Murshed, Bothell, WA (US); S M Hasibul Haque, Redmond, WA (US); Ryan Matthew Turner, Seattle, WA (US); Raida Karim, Seattle, WA (US); Hari Vamsi Yadavalli, Sunnyvale, WA (US)

(21) Appl. No.: 19/459,128

(22) Filed: Jan. 26, 2026

Related U.S. Application Data
(60) Provisional application No. 63/750,318, filed on Jan. 28, 2025.

(51) Int. Cl. G06F 16/332; G06F 16/334

(52) U.S. Cl. CPC G06F 16/3326; G06F 16/3344

(57) ABSTRACT

An AI-based system and method for automatically orchestrating development operation tasks within dynamic computing environments, using an action registry are disclosed. The AI-based system initially obtains natural language instructions from users. The AI-based system further processes the natural language instructions to extract objective data from the natural language instructions. The AI-based system further generates execution plans by analyzing the objective data using an LLM. The AI-based system further automatically orchestrates the development operation tasks by generating actions using a selection of tools from the action registry, for executing the development operation tasks identified in the execution plans. The AI-based system further generates comprehensive reports associated with the execution of the development operation tasks, along with orchestration results. The AI-based system further provides the generated comprehensive reports with the orchestration results, as an output, to the users through user interfaces associated with electronic devices of the users.

### CROSS REFERENCE TO RELATED APPLICATIONS

This application claims the priority to incorporate by reference the entire disclosure of U.S. provisional patent application No. 63/750,318 filed on January 28, 2025, titled “SYSTEM AND METHOD FOR PERFORMING ACTIONS ON ADAPTIVE KNOWLEDGE GRAPHS WITH INFRASTRUCTURE PROVISIONING AND DEVELOPMENT OPERATIONS (DEVOPS) OPTIMIZATION”.

### TECHNICAL FIELD

Embodiments of the present disclosure relate to artificial intelligence (AI) based workflow automation systems and more particularly relate to an AI-based system and method for automatically orchestrating one or more development operation tasks by generating one or more actions for the one or more development operation tasks within one or more dynamic computing environments using an action registry.

### BACKGROUND

In recent years, organizations have increasingly embraced cloud computing and hybrid infrastructures to meet demands of scalability, flexibility, and resource optimization. The cloud computing and hybrid infrastructures allow the organizations to leverage one or more cloud providers alongside on-premise infrastructure, enabling the organizations to scale operations dynamically and efficiently. However, managing such complex, distributed systems introduce several challenges, particularly when it comes to orchestrating workflows, automating resource provisioning, and ensuring seamless integration across various platforms. As a result, traditional methods of managing and configuring the cloud computing and hybrid infrastructure are no longer sufficient to support agility and innovation that modern enterprises require.

The growing complexity of the cloud computing and hybrid infrastructures necessitates the use of automation tools and orchestration systems to manage the workflows. Modern development operations (DevOps) practices rely heavily on automation for continuous integration/continuous deployment (CI/CD) pipelines, infrastructure as code (IaC), and monitoring. The CI/CD pipelines and the IaC are configured to reduce human error, increase efficiency, and improve reliability by automating repetitive tasks such as provisioning, configuration, and deployment. However, current systems lack intelligent decision-making capabilities, which results in inefficient workflows and suboptimal resource allocation. Additionally, many tools are not well integrated with each other, leading to fragmented processes that are difficult to scale and adapt as the cloud computing and hybrid infrastructures evolve.

A key issue with existing systems is the integration of security measures into the automated workflows. As the organizations move more critical workloads to the cloud computing and hybrid infrastructures and adopt microservices architectures, maintaining security across a wide range of systems and services becomes increasingly difficult. The current systems focus on one of: automation and security, but fail to combine one of: the automation and the security effectively. Many tools lack built-in features such as role-based access control (RBAC), real-time security checks, and comprehensive logging for monitoring user actions and tool invocations. Without the built-in features, the organizations are left vulnerable to security breaches and misconfigurations that go undetected, thereby causing significant damage to the cloud computing and hybrid infrastructure, data integrity, and business operations.

Prior art in workflow orchestration and automation relies on isolated tools and frameworks that automate specific aspects of one or more DevOps tasks. The prior arts automate infrastructure provisioning, but do not provide dynamic decision-making and intelligent reasoning to optimize the workflows. Some prior arts simplify container orchestration but may not address end-to-end automation, security, and dependency management across the cloud computing and hybrid infrastructures and the on-premise environments. While the tools are effective in the individual domains, the tools fail to integrate into a cohesive, intelligent system capable of managing the complex workflows and responding dynamically to changes in real time.

Therefore, there is a need for an improved artificial intelligence (AI) based system and method that automatically orchestrates development operation (DevOps) tasks within dynamic computing environments, using an action registry. Further, the AI-based system integrates the security measures, real-time analysis, and advanced reasoning capabilities to automate and optimize the one or more DevOps tasks, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an artificial intelligence (AI) based method for automatically orchestrating one or more development operation tasks within one or more dynamic computing environments, using an action registry, is disclosed. The AI-based method comprises obtaining, by one or more hardware processors, one or more natural language instructions from one or more user interfaces associated with one or more electronic devices of one or more users. The AI-based method further comprises processing, by the one or more hardware processors, the one or more natural language instructions to extract objective data from the one or more natural language instructions to determine accurate interpretation and initiation of execution of the one or more development operation tasks. The objective data comprises at least one of: one or more objectives, one or more circumstances, and one or more parameters and constraints.

The AI-based method further comprises generating, by the one or more hardware processors, one or more execution plans by analyzing the objective data using a large language model (LLM). The AI-based method further comprises automatically orchestrating, by the one or more hardware processors, the one or more development operation tasks by generating one or more actions using a selection of one or more tools from the action registry, for executing the one or more development operation tasks identified in the one or more execution plans.

The AI-based method further comprises generating, by the one or more hardware processors, one or more comprehensive reports associated with the execution of the one or more development operation tasks, along with orchestration results. The AI-based method further comprises providing, by the one or more hardware processors, the generated one or more comprehensive reports with the orchestration results, as an output, to the one or more users through the one or more user interfaces associated with the one or more electronic devices of the one or more users.

In an embodiment, processing the one or more natural language instructions to extract the objective data comprises: (a) translating, by the one or more hardware processors, the one or more natural language instructions into one or more actionable workflows for orchestration of the one or more development operation tasks; (b) identifying, by the one or more hardware processors, the one or more objectives from the one or more natural language instructions, wherein the one or more objectives comprise at least one of: simulation, optimization, and monitoring, of the one or more development operation tasks performed within the one or more dynamic computing environments; (c) identifying, by the one or more hardware processors, the one or more circumstances from the one or more natural language instructions, wherein the one or more circumstances comprise infrastructure and environment related to a development operation task of the one or more development operation tasks; and (d) identifying, by the one or more hardware processors, the one or more parameters and constraints from the one or more natural language instructions, wherein the one or more parameters and constraints comprise at least one of: timeframes, budgets, and specific tools, for execution of the one or more development operation tasks. The extracted objective data forms a semantic blueprint that defines the one or more development operation tasks and conditions required for execution of the one or more development operation tasks.

In another embodiment, generating the one or more execution plans by analyzing the objective data using the LLM, comprises: (a) generating, by the one or more hardware processors, a structured framework detailing the one or more development operation tasks, wherein the structured framework comprises one or more action workflows in one or more structured formats; (b) determining, by the one or more hardware processors, one or more dependencies between the one or more development operation tasks; (c) utilizing, by the one or more hardware processors, topological sorting technique to prioritize the one or more development operation tasks based on the one or more dependencies; (d) determining, by the one or more hardware processors, one or more steps required to achieve one or more results associated with the execution of the one or more development operation tasks; and (e) dynamically adapting, by the one or more hardware processors, each step of the one or more steps to real-time conditions using a feedback loop and multi-turn reasoning to refine an approach during execution of the one or more development operation tasks, for determining accuracy and reliability for complex one or more development operation tasks.

In yet another embodiment, selecting the one or more tools from the action registry for executing the one or more development operation tasks with the orchestration results, comprises: (a) accessing, by the one or more hardware processors, the action registry to retrieve one or more tools, wherein the action registry acts as a centralized repository that stores the one or more tools and functionalities required for executing the one or more development operation tasks within the one or more dynamic computing environments; (b) retrieving, by the one or more hardware processors, metadata associated with each tool of the one or more tools, wherein the metadata comprises at least one of: reliability, latency, and domain applicability, corresponding to each tool of the one or more tools; (c) assessing, by the one or more hardware processors, performance characteristics and suitability of the one or more tools for the one or more development operation tasks based on the retrieved metadata associated with each tool of the one or more tools; (d) analyzing, by the one or more hardware processors, historical performance data to learn from past tool performance and success rates associated with the execution of the one or more development operation tasks with the orchestration results, for adapting the one or more tools to changes in requirements of the one or more dynamic computing environments and resource constraints; and (e) applying, by the one or more hardware processors, a scoring mechanism to rank and select an optimized efficient and reliable tool of the one or more tools for each operation associated with the one or more development operation tasks.

In yet another embodiment, selecting the one or more tools comprises at least one of: (a) selecting, by the one or more hardware processors, a knowledge action tool that is configured to maintain an adaptive and real-time map of one or more resources, dependencies, and configurations, within the one or more dynamic computing environments, wherein the knowledge action tool is configured to visualize intricate interrelationships between the one or more resources and provide a comprehensive view of how one or more components of the one or more dynamic computing environments depend on each other for real-time analysis and impact assessment; (b) selecting, by the one or more hardware processors, an application programming interface (API) action tool that is configured to facilitate one or more external API calls; and (c) selecting, by the one or more hardware processors, a plugin action tool that is configured to run one or more internal tools for the one or more dynamic computing tasks.

In yet another embodiment, the AI-based method further comprising performing, by the one or more hardware processors, one or more operations using the knowledge action tool, comprises: (a) assessing, by the one or more hardware processors, potential impact of changes and failures within the one or more dynamic computing environments, by employing one or more adaptive knowledge graphs; and (b) processing, by the one or more hardware processors, the one or more natural language instructions related to resource dependencies and configurations for retrieving one or more related resources and analyzing a current state of the one or more dynamic computing environments.

In yet another embodiment, the AI-based method further comprising: (a) monitoring, by the one or more hardware processors, a progress of each development operation task of the one or more development operation tasks in real-time;; (b) determining, by the one or more hardware processors, whether the one or more development operation tasks fail during execution of the one or more development operation tasks; (c) upon detection of a failure during the execution of the one or more development operation tasks, reattempting, by the one or more hardware processors, the failed one or more development operation tasks automatically using one or more retry mechanisms, for mitigating disruption in an action workflow; and (d) managing, by the one or more hardware processors, at least one of: tool failures and process failures using one or more fallback mechanisms, wherein the one or more fallback mechanisms are configured to at least one of: switch to one or more alternative tools and flag an issue for manual intervention.

In an aspect, an artificial intelligence based (AI-based) system for automatically orchestrating one or more development operation tasks within one or more dynamic computing environments, using an action registry, is disclosed. The AI-based system comprises one or more hardware processors and a memory unit. The memory unit is operatively coupled to the one or more hardware processors. The memory unit comprises a plurality of subsystems in form of machine-readable instructions executable by the one or more hardware processors.

The plurality of subsystems comprises an instruction obtaining subsystem configured to obtain one or more natural language instructions from one or more user interfaces associated with one or more electronic devices of one or more users. The plurality of subsystems further comprises an instruction processing generating subsystem configured to process the one or more natural language instructions to extract objective data from the one or more natural language instructions to determine accurate interpretation and initiation of execution of the one or more development operation tasks. The objective data comprises at least one of: one or more objectives, one or more circumstances, and one or more parameters and constraints.

The plurality of subsystems further comprises a reasoning orchestrating generating subsystem configured to generate one or more execution plans by analyzing the objective data using a large language model (LLM). The plurality of subsystems further comprises an action orchestrating subsystem configured to automatically orchestrate the one or more development operation tasks by generating one or more actions using a selection of one or more tools from the action registry, for executing the one or more development operation tasks identified in the one or more execution plans.

The plurality of subsystems further comprises a report generating subsystem configured to generate one or more comprehensive reports associated with the execution of the one or more development operation tasks, along with orchestration results. The plurality of subsystems further comprises an output subsystem configured to automatically provide the generated one or more comprehensive reports with the orchestration results, as an output, to the one or more users through the one or more user interfaces associated with the one or more electronic devices of the one or more users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a network architecture depicting an artificial intelligence based (AI-based) system for automatically orchestrating one or more development operation tasks within one or more dynamic computing environments, using an action registry, in accordance with an embodiment of the present disclosure;

FIG. 2 illustrates a detailed view of the AI-based system, such as those shown in FIG. 1, for automatically orchestrating the one or more development operation tasks within the one or more dynamic computing environments, using the action registry, in accordance with an embodiment of the present disclosure;

FIG. 3 illustrates an exemplary flow diagram representation of the AI-based system for automatically orchestrating the one or more development operation tasks within the one or more dynamic computing environments, using the action registry, in accordance with an embodiment of the present disclosure; and

FIG. 4 is a flow chart illustrating an AI-based method for automatically orchestrating the one or more development operation tasks within the one or more dynamic computing environments, using the action registry, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises… a" does not, without more constraints, preclude the existence of other devices, sub-systems, additional sub-modules. Appearances of the phrase "in an embodiment”, "in another embodiment" and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

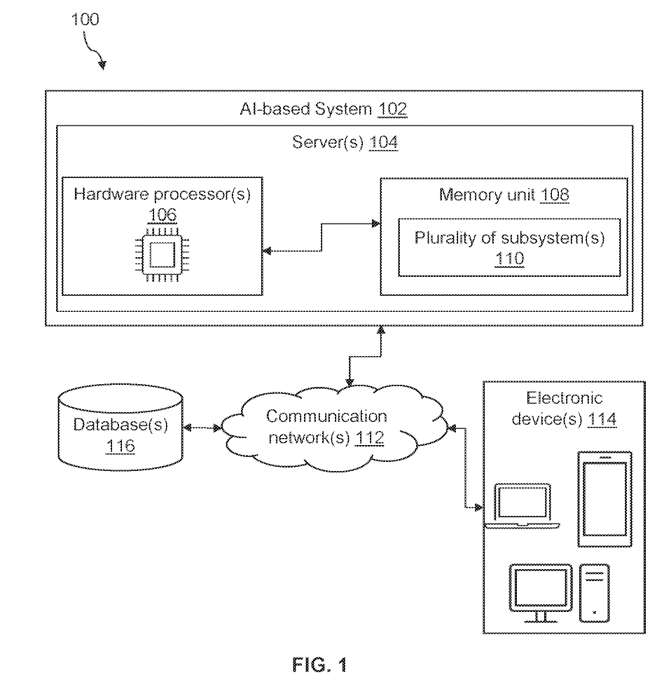

Referring now to the drawings, and more particularly to FIG. 1 through FIG. 4, where similar reference characters denote corresponding features consistently throughout the figures, there are shown preferred embodiments and these embodiments are described in the context of the following exemplary system and/or method.

FIG. 1 illustrates an exemplary block diagram representation of a network architecture 100 depicting an AI-based system 102 for automatically orchestrating the one or more development operation tasks within the one or more dynamic computing environments, using the action registry, in accordance with an embodiment of the present disclosure.

According to an exemplary embodiment of the present disclosure, the network architecture 100 may include the AI-based system 102, one or more databases 116, and one or more electronic devices 114. The AI-based system 102, the one or more databases 116, and the one or more electronic devices 114 may be communicatively coupled via one or more communication networks 112, ensuring seamless data transmission, processing, and decision-making. The AI-based system 102 acts as a central processing unit within the network architecture 100, responsible for executing the one or more development operations (DevOps) tasks. The AI-based system 102 is configured to execute a set of computer-readable instructions that control a plurality of subsystems 110.

The present invention with the AI-based system 102 automatically orchestrates the one or more development operation tasks within the one or more dynamic computing environments, using the action registry The automatic orchestration involves generating one or more actions for the execution of the one or more development operation tasks with infrastructure provisioning and development operations (DevOps) optimization using a selection of one or more tools (such as a knowledge action tool employing one or more adaptive knowledge graphs, an application programming interface (API) action tool, and a plugin action tool).

The AI-based system 102 is initially configured to obtain one or more natural language instructions from one or more user interfaces associated with one or more electronic devices 114 of one or more users. The AI-based system 102 is further configured to process the one or more natural language instructions to extract objective data from the one or more natural language instructions to determine accurate interpretation and initiation of execution of the one or more development operation tasks. In an embodiment, the objective data comprises at least one of: one or more objectives, one or more circumstances, and one or more parameters and constraints.

The AI-based system 102 is further configured to generate one or more execution plans by analyzing the objective data using a large language model (LLM). The AI-based system 102 is further configured to automatically orchestrate the one or more development operation tasks by generating one or more actions using a selection of one or more tools from the action registry, for executing the one or more development operation tasks identified in the one or more execution plans. The AI-based system 102 is further configured to generate one or more comprehensive reports associated with the execution of the one or more development operation tasks, along with orchestration results. The AI- based system 102 is further configured to automatically provide the generated one or more comprehensive reports with the orchestration results, as an output, to the one or more users through the one or more user interfaces associated with the one or more electronic devices 114 of the one or more users.

In an exemplary embodiment, the AI-based system 102 comprises one or more servers 104. The one or more servers 104 may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or one or more hardware processors 106.

The one or more servers 104 comprise the one or more hardware processors 106 and a memory unit 108 (i.e., a memory). The memory unit 108 is operatively connected to the one or more hardware processors 106. The memory unit 108 comprises a set of computer-readable instructions in the form of the plurality of subsystems 110, configured to be executed by the one or more hardware processors 106.

In an exemplary embodiment, the one or more hardware processors 106 may include, for example, microprocessors, microcomputers, microcontrollers, digital signal processors, central processing units, state machines, logic circuits, and/or any devices that manipulate data or signals based on operational instructions. Among other capabilities, the one or more hardware processors 106 may fetch and execute computer-readable instructions in the memory unit 108 operationally coupled with the AI-based system 102 for performing tasks such as data processing, input/output processing, and/or any other functions. Any reference to a task in the present disclosure may refer to an operation being or that may be performed on data. The one or more hardware processors 106 are high-performance processors capable of handling large volumes of data and complex computations. The one or more hardware processors 106 may be, but not limited to, at least one of: multi-core central processing units (CPU), graphics processing units (GPUs), and the like, that enhance an ability of the AI-based system 102 to process real-time data from one or more sources simultaneously.

In an exemplary embodiment, the one or more databases 116 may be configured to store and manage data related to various aspects of the AI-based system 102. The one or more databases 116 may store at least one of, but not limited to, the one or more adaptive knowledge graphs, API data, plugin data, objective data, any other information necessary for the functionality and optimization of the AI-based system 102, and the like. The one or more databases 116 serve as a centralized repository for critical data elements that are integral to the secure operation of the AI-based system 102, enabling efficient execution of the one or more DevOps tasks. The one or more databases 116 enable the AI-based system 102 to dynamically retrieve, analyze, and update the stored data in real-time, for executing the one or more DevOps tasks. The one or more databases 116 may include different types of databases such as, but not limited to, relational databases (e.g., Structured Query Language (SQL) databases such as PostgresDB and Oracle^{®} databases), non-Structured Query Language (NoSQL) databases (e.g., MongoDB, Cassandra), time-series databases (e.g., InfluxDB), an OpenSearch database, a graph database, a vector database, object storage systems (e.g., Amazon^{®} S3), and the like.

In an exemplary embodiment, the one or more electronic devices 114 are configured to enable the one or more users to interact with the AI-based system 102. The one or more electronic devices 114 may be digital devices, computing devices, and/or networks. The one or more electronic devices 114 may include, but not limited to, a mobile device, a smartphone, a personal digital assistant (PDA), a tablet computer, a phablet computer, a wearable computing device, a virtual reality/augmented reality (VR/AR) device, a laptop, a desktop, and the like.

In an exemplary embodiment, the one or more electronic devices 114 may be associated with the one or more users comprising, but not limited to, one or more service providers, one or more customers, an individual, an administrator, a vendor, a technician, a specialist, an instructor, a supervisor, a team, an entity, an organization, a company, a facility, a bot, any other user, and combination thereof. The entity, the organization, and the facility may include, but not limited to, an e-commerce company, online marketplaces, service providers, retail stores, a merchant organization, a logistics company, warehouses, transportation company, an airline company, a hotel booking company, a hospital, a healthcare facility, an exercise facility, a laboratory facility, a company, an outlet, a manufacturing unit, an enterprise, an organization, an educational institution, a secured facility, a warehouse facility, a supply chain facility, any other facility/organization and the like.

In an exemplary embodiment, the one or more communication networks 112 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fiber optic network, a satellite network, a cloud computing network, a combination of networks, and the like. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth^{®}, ZigBee^{®}, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like.

In an exemplary embodiment, the AI-based system 102 may be implemented by way of a single device or a combination of multiple devices that may be operatively connected or networked together. The AI-based system 102 may be implemented in hardware or a suitable combination of hardware and software.

Though few components and the plurality of subsystems 110 are disclosed in FIG. 1, there may be additional components and subsystems which is not shown, such as, but not limited to, ports, routers, repeaters, firewall devices, network devices, the one or more databases 116, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the AI-based system 102, and the one or more electronic devices 114 connected to the one or more databases 116, one skilled in the art can envision that the AI-based system 102, and the one or more electronic devices 114 may be connected to several user devices located at various locations and several databases via the one or more communication networks 112.

Those of ordinary skilled in the art will appreciate that the hardware depicted in FIG. 1 may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the AI-based system 102 as is unique to the present disclosure or necessary for an understanding of the present disclosure is depicted and described. The remainder of the construction and operation of the AI-based system 102 may conform to any of the various current implementations and practices that were known in the art.

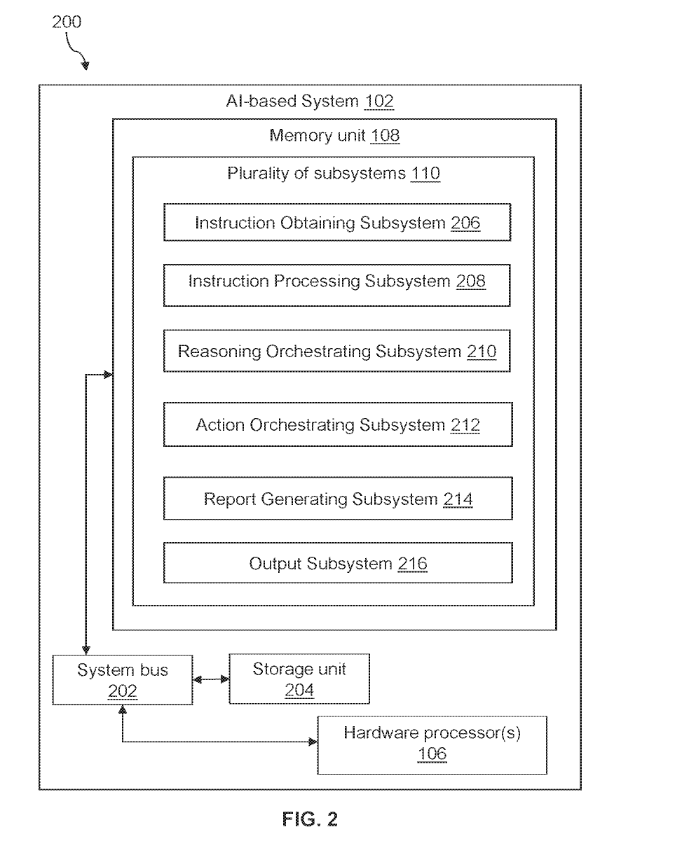

FIG. 2 illustrates a detailed view 200 of the AI-based system 102, such as those shown in FIG. 1, for automatically orchestrating the one or more development operation tasks within the one or more dynamic computing environments, using the action registry, in accordance with an embodiment of the present disclosure.

In an exemplary embodiment, the AI-based system 102 comprises the one or more servers 104, the memory unit 108, and a storage unit 204. The one or more hardware processors 106, the memory unit 108, and the storage unit 204 are communicatively coupled through a system bus 202 or any similar mechanism. The system bus 202 functions as the central conduit for data transfer and communication between the one or more hardware processors 106, the memory unit 108, and the storage unit 204. The system bus 202 facilitates the efficient exchange of information and instructions, enabling the coordinated operation of the AI-based system 102. The system bus 202 may be implemented using various technologies, including but not limited to, parallel buses, serial buses, and high-speed data transfer interfaces such as, but not limited to, at least one of a: universal serial bus (USB), peripheral component interconnect express (PCIe), and similar standards.

In an exemplary embodiment, the memory unit 108 is operatively connected to the one or more hardware processors 106. The memory unit 108 comprises the plurality of subsystems 110 in the form of programmable instructions executable by the one or more hardware processors 106. The plurality of subsystems 110 comprises an instruction obtaining subsystem 206, an instruction processing subsystem 208, a reasoning orchestrating subsystem 210, an action orchestrating subsystem 212, a report generating subsystem 214, and an output subsystem 216.

The one or more hardware processors 106 associated within the one or more servers 104, as used herein, means any type of computational circuit, such as, but not limited to, the microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 106 may also include embedded controllers, such as generic or programmable logic devices or arrays, application-specific integrated circuits, single-chip computers, and the like.

The memory unit 108 may be the non-transitory volatile memory and the non-volatile memory. The memory unit 108 may be coupled to communicate with the one or more hardware processors 106, such as being a computer-readable storage medium. The one or more hardware processors 106 may execute machine-readable instructions and/or source code stored in the memory unit 108. A variety of machine-readable instructions may be stored in and accessed from the memory unit 108. The memory unit 108 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 108 includes the plurality of subsystems 110 stored in the form of machine-readable instructions on any of the above-mentioned storage media and may be in communication with and executed by the one or more hardware processors 106.

The storage unit 204 may be a cloud storage or the one or more databases 116 such as those shown in FIG. 1. The storage unit 204 may store, but not limited to, recommended course of action sequences dynamically generated by the system 102. The action sequences comprise instructions obtaining, instructions processing, reasoning orchestrating, action orchestrating, report generating, and the like. Additionally, the storage unit 204 may retain previous action sequences for comparison and future reference, enabling continuous refinement of the AI-based system 102 over time. The storage unit 204 may be any kind of database such as, but not limited to, relational databases, dedicated databases, dynamic databases, monetized databases, scalable databases, cloud databases, distributed databases, any other databases, and a combination thereof.

The plurality of subsystems 110 includes the instruction obtaining subsystem 206 that is communicatively connected to the one or more hardware processors 106. The instruction obtaining subsystem 206 is configured to serve as an entry point for user interactions. The instructions obtaining subsystem 206 is configured to obtain the one or more instructions (natural language instructions) from the one or more user interfaces associated with the one or more electronic devices 114 of the one or more users. The one or more users may provide the one or more instructions through a user interface associated with the one or more electronic devices 114 (i.e., communication devices). The one or more natural language instructions are commands or requests expressed in everyday human language, such as English, rather than in programming code or technical syntax. The one or more user interfaces may be any graphical or text-based interface displayed on the one or more electronic devices 114 that allow the one or more users to input commands and view results. For instance, an instruction may be "Simulate a cost of a security breach," received from the one or more user interfaces associated with the one or more electronic devices 114 of the one or more users.

The plurality of subsystems 110 includes the instruction processing subsystem 208 that is communicatively connected to the one or more hardware processors 106. The instructions processing subsystem 208 is configured to process the one or more natural language instructions to extract the objective data from the one or more natural language instructions to determine the accurate interpretation and initiation of execution of the one or more development operation tasks. In an embodiment, the objective data may include at least one of: one or more objectives, one or more circumstances, and one or more parameters and constraints.

The instruction processing subsystem 208 is a component of the AI-based system 102 that receives the one or more natural language instructions from the instruction obtaining subsystem 206 and transforms them into a structured format suitable for downstream processing. Natural language processing techniques may be employed to parse the one or more natural language instructions, identify key entities, and extract relevant information. The instruction processing subsystem 208 may utilize tokenization to break down the one or more natural language instructions into individual words or phrases, part-of-speech tagging to identify grammatical components, and named entity recognition to identify specific resources, services, or configurations mentioned in the one or more natural language instructions.

In some aspects, the instruction processing subsystem 208 may employ machine learning models trained on domain-specific data to improve accuracy in understanding DevOps-related terminology and context. The instruction processing subsystem 208 may also perform intent classification to determine the type of action the one or more users wish to perform, such as provisioning, monitoring, scaling, or troubleshooting. Ambiguity resolution techniques may be applied when the one or more instructions contain unclear or conflicting information, and the instruction processing subsystem 208 may prompt the one or more users for clarification when necessary. The instruction processing subsystem 208 may maintain a context window to track previous instructions in a session, enabling it to understand follow-up commands that reference earlier requests.

For example, if a user provides an instruction such as “Deploy the application to the staging environment with two replicas,” the instruction processing subsystem 208 parses this instruction to identify the action (deploy), the target (application), the destination (staging environment), and the configuration parameter (two replicas), and structures this information as objective data for the reasoning orchestrator subsystem 210 to generate an appropriate execution plan.

For processing the one or more natural language instructions to extract the objective data, the instruction processing subsystem 208 is configured to translate the one or more natural language instructions into one or more actionable workflows for orchestration of the one or more development operation tasks. The one or more actionable workflows are structured sequences of operations that the system can execute, derived from converting user instructions into a machine-processable format. For example, a user instruction "scale up the database servers" may be translated into an actionable workflow comprising steps such as identifying current server capacity, determining target capacity, and initiating provisioning commands.

The instruction processing subsystem 208 is further configured to identify the one or more objectives from the one or more natural language instructions. The one or more objectives comprise at least one of: simulation, optimization, and monitoring, of the one or more development operation tasks performed within the one or more dynamic computing environments. The one or more objectives are the goals or desired outcomes that the one or more users seek to accomplish through the development operation tasks. The simulation objectives may involve modeling potential scenarios such as predicting system behavior under increased load. The optimization objectives may involve improving resource utilization or reducing latency. The monitoring objectives may involve tracking system health, performance metrics, or security events. For example, an objective extracted from "monitor CPU usage across all production servers" would be monitoring.

The instruction processing subsystem 208 is further configured to identify the one or more circumstances from the one or more natural language instructions. The one or more circumstances comprise infrastructure and environment related to a development operation task of the one or more development operation tasks. The one or more circumstances are the contextual factors describing the infrastructure and environment where the development operation tasks will be performed. The one or more circumstances may include the type of cloud platform being used, the network topology, the operating system of target machines, or the current state of deployed services. For example, circumstances extracted from “deploy the service to the AWS production cluster” would include AWS as the cloud platform and production as the environment type.

The instruction processing subsystem 208 is further configured to identify the one or more parameters and constraints from the one or more natural language instructions. The one or more parameters and constraints comprise at least one of: timeframes, budgets, and specific tools, for execution of the one or more development operation tasks. The one or more parameters and constraints are the specific requirements and limitations that govern how the development operation tasks should be executed. The timeframes may specify deadlines or maintenance windows. The budgets may define cost limits for resource provisioning. The specific tools may indicate preferred utilities or platforms for task execution. For example, the one or more parameters extracted from “complete the migration within 4 hours using Terraform” would include a 4-hour timeframe and Terraform as the specific tool.

The semantic blueprint is a structured representation that captures the complete meaning and intent of the user's instructions, combining the identified objectives, circumstances, and parameters into a unified format that defines what tasks need to be performed and under what conditions.

The plurality of subsystems 110 includes the reasoning orchestrating subsystem 210 that is communicatively connected to the one or more hardware processors 106. The reasoning orchestrating subsystem 210 is configured to generate the one or more execution plans by analyzing the objective data using the large language model (LLM). The reasoning orchestrating subsystem 210 is a component of the AI-based system 102 that receives the objective data from the instruction processing subsystem 208 and determines how to accomplish the user's goals by creating a plan of action. The reasoning orchestrating subsystem 210 employs logical analysis to break down complex requests into manageable steps and identify the order in which tasks should be performed. For example, if the objective data indicates a need to migrate a database to a new server, the reasoning orchestrating subsystem 210 determines that data backup should occur before migration, and verification should occur after migration.

The one or more execution plans are, structured frameworks that outline the specific development operation tasks to be performed, the sequence in which they should be executed, and the relationships between the one or more tasks. An execution plan may specify that Task A must complete before Task B begins, or that Tasks C and D can run simultaneously. For example, an execution plan for deploying a web application may include steps such as pulling the latest code, running tests, building container images, pushing images to a registry, and updating the deployment configuration.

The Large language model (LLM) is an artificial intelligence model trained on extensive text data that enables the AI-based system 102 to understand context, reason about complex scenarios, and generate appropriate responses. The LLM assists the reasoning orchestrating subsystem 210 in interpreting the objective data, understanding the relationships between different components, and formulating logical execution plans. The LLM may consider factors such as best practices, potential risks, and optimization opportunities when generating the execution plan. For example, when analyzing objective data for a security audit task, the LLM may reason that vulnerability scanning should precede penetration testing, and that results should be compiled into a report upon completion.

For generating the one or more execution plans by analyzing the objective data using the LLM, the reasoning orchestrating subsystem 210 is configured to generate a structured framework detailing the one or more development operation tasks. The structured framework comprises one or more action workflows in one or more structured formats. The structured framework is an organized representation that details the one or more development operation tasks in a systematic manner, enabling the reasoning orchestrating subsystem 210 to understand what needs to be accomplished and how tasks relate to one another. The structured framework may be expressed in one or more structured formats such as JavaScript Object Notation (JSON), Extensible Markup Language (XML), Yet Another Markup Language (YAML), or other machine-readable formats that allow for consistent parsing and execution. For example, a structured framework for deploying a microservices application may be represented as a JSON document containing task definitions, input parameters, expected outputs, and execution sequences.

The reasoning orchestrating subsystem 210 is further configured to determine one or more dependencies between the one or more development operation tasks. The one or more dependencies are relationships between development operation tasks where one task relies on the completion or output of another task before it can begin execution. The one or more dependencies ensure that the one or more tasks are executed in a logical order that respects prerequisites and avoids conflicts. For example, a task to start a web server depends on a prior task that installs the web server software, and a task to configure a database connection depends on a prior task that provisions the database instance.

The reasoning orchestrating subsystem 210 is further configured to utilize topological sorting technique to prioritize the one or more development operation tasks based on the one or more dependencies. The topological sorting technique is an algorithmic method used to arrange the one or more development operation tasks in a linear order such that for every dependency relationship, the prerequisite task appears before the dependent task in the sequence. This technique ensures that no task is attempted before its required predecessor tasks have completed. For example, if Task A must complete before Task B, and Task B must complete before Task C, topological sorting produces the order A, B, C.

The reasoning orchestrating subsystem 210 is further configured to determine one or more steps required to achieve one or more results associated with the execution of the one or more development operation tasks. The one or more steps are individual discrete operations or actions that must be performed in sequence or in parallel to complete a development operation task and achieve the desired results. Each step represents a specific unit of work such as executing a command, invoking an API, modifying a configuration file, or validating an output. The one or more steps may have inputs, outputs, and conditions that determine whether they should execute. For example, to achieve the result of deploying an updated application, the one or more steps may include pulling the latest code from a repository, building the application, running unit tests, creating a container image, pushing the image to a registry, and updating the deployment manifest in the target environment.

The reasoning orchestrating subsystem 210 is further configured to dynamically adapt each step of the one or more steps to real-time conditions using a feedback loop and multi-turn reasoning to refine an approach during execution of the one or more development operation tasks, for determining accuracy and reliability for complex one or more development operation tasks. The feedback loop is a mechanism that captures information about the outcomes of executed steps and provides this information back to the reasoning orchestrating subsystem 210 to inform subsequent decisions. The feedback loop enables the reasoning orchestrating subsystem 210 to learn from intermediate results and adjust the execution approach accordingly. For example, if a deployment step returns a warning about low disk space, the feedback loop communicates this information so that a cleanup step can be inserted before proceeding. The multi-turn reasoning is an iterative process where the reasoning orchestrating subsystem 210 engages in multiple rounds of analysis and decision-making to refine the execution approach progressively. Each turn of reasoning considers new information, updated conditions, or results from previous steps to improve the accuracy and reliability of the execution plan. For example, during a complex infrastructure migration, multi-turn reasoning may involve an initial assessment turn, a resource allocation turn, a risk evaluation turn, and a final optimization turn, with each turn building upon insights gained from previous turns to produce a more robust execution strategy.

The plurality of subsystems 110 includes the action orchestrating subsystem 212 that is communicatively connected to the one or more hardware processors 106. The action orchestrating subsystem 212 is configured to automatically orchestrate the one or more development operation tasks by generating the one or more actions using the selection of the one or more tools from the action registry, for executing the one or more development operation tasks identified in the one or more execution plans.

The action orchestrating subsystem 212 is a component of the AI-based system 102 that takes the execution plans generated by the reasoning orchestrating subsystem 210 and carries out the actual execution of the development operation tasks. The action orchestrating subsystem 212 coordinates the selection of appropriate tools, manages the sequence of operations, and ensures that each task is performed according to the plan. For example, when an execution plan specifies deploying a containerized application, the action orchestrating subsystem 212 coordinates the container build process, image registry operations, and deployment commands.

The one or more actions are specific executable operations that the action orchestrating subsystem 212 performs to accomplish the development operation tasks. Each action corresponds to a concrete activity such as sending a request, running a script, querying a database, or invoking a service. The one or more actions are the tangible work units that transform the abstract execution plan into real changes within the computing environment. For example, the one or more actions for a server provisioning task may include creating a virtual machine instance, assigning network configurations, installing required software packages, and registering the server with a monitoring service.

The one or more tools are software utilities, services, or functional modules that the action orchestrating subsystem 212 employs to perform specific actions within the development operation tasks. The one or more tools may include command-line utilities, APIs, scripts, plugins, or external services that provide specialized capabilities. Each tool is designed to handle particular types of operations within the computing environment. For example, the one or more tools may include infrastructure provisioning utilities, container orchestration platforms, configuration management software, or security scanning applications.

For selecting the one or more tools from the action registry for executing the one or more development operation tasks with the orchestration results, the action orchestrating subsystem 212 is configured to access the action registry to retrieve one or more tools. The action registry acts as a centralized repository that stores the one or more tools and functionalities required for executing the one or more development operation tasks within the one or more dynamic computing environments. In other words, the action registry is a centralized repository that stores and manages the collection of available tools and their associated metadata, enabling the action orchestrating subsystem 212 to discover and select appropriate tools for each action, once the high execution plan is created. The action registry maintains information about each tool's capabilities, requirements, performance characteristics, and usage patterns. For example, the action registry may contain entries for multiple database backup tools, each with metadata indicating supported database types, backup speeds, compression options, and reliability ratings, allowing the system to select the most suitable tool for a given backup action.

The action orchestrating subsystem 212 is further configured to retrieve metadata associated with each tool of the one or more tools, wherein the metadata comprises at least one of: reliability, latency, and domain applicability, corresponding to each tool of the one or more tools. The metadata is descriptive information associated with each tool that characterizes its operational properties and helps the action orchestrating subsystem 212 evaluate whether the tool is appropriate for a given task. The metadata provides a standardized way to compare different tools and make informed selection decisions. For example, metadata for a cloud deployment tool may indicate that it has 99.5% reliability, average latency of 200 milliseconds, and is applicable to container orchestration and serverless deployment domains.

The metadata may include at least one of: reliability, latency, and domain applicability, corresponding to each tool of the one or more tools. The metadata is crucial for a prioritization process, where the action orchestrating subsystem 212 selects the most appropriate plurality of tools based on a scoring mechanism (explained in subsequent paragraphs), ensuring that the most efficient and reliable plurality of tools is used for each operation. The reliability is a measure of how consistently and dependably a tool performs its intended function without failure or error. The reliability may be expressed as a percentage indicating the success rate of tool invocations over a period of time. For example, a configuration management tool with 98% reliability successfully completes its operations 98 out of 100 times it is invoked. The latency is a measure of the time delay between initiating a tool's operation and receiving the result or completion of that operation. Lower latency indicates faster tool performance, which may be important for time-sensitive development operation tasks. For example, a monitoring tool with 50 milliseconds latency returns system health metrics within 50 milliseconds of being queried. The domain applicability is an indication of the specific areas, technologies, or types of tasks for which a tool is designed and suited. Domain applicability helps the action orchestrating subsystem 212 match tools to tasks that fall within their intended scope of functionality. For example, a tool may have domain applicability for network configuration, security scanning, or database management, indicating the types of tasks it can effectively perform.

The action orchestrating subsystem 212 is further configured to assess performance characteristics and suitability of the one or more tools for the one or more development operation tasks based on the retrieved metadata associated with each tool of the one or more tools. The performance characteristics are the operational attributes of a tool that describe how it behaves during execution, including factors such as speed, resource consumption, throughput, and scalability. The performance characteristics help the action orchestrating subsystem 212 predict how a tool will perform under various conditions. For example, performance characteristics of a log analysis tool may indicate that it can process 10,000 log entries per second and scales linearly with additional computing resources.

The action orchestrating subsystem 212 is further configured to analyze historical performance data to learn from past tool performance and success rates associated with the execution of the one or more development operation tasks with the orchestration results, for adapting the one or more tools to changes in requirements of the one or more dynamic computing environments and resource constraints. The historical performance data is recorded information about how tools have performed in past executions, including success rates, failure patterns, execution times, and outcomes. The action orchestrating subsystem 212 analyzes historical performance data to identify trends, detect degradation, and make predictions about future tool behavior. For example, historical performance data may reveal that a particular backup tool has experienced increased failure rates during peak usage hours, informing the action orchestrating subsystem 212 to select an alternative tool during those times.

The action orchestrating subsystem 212 is further configured to apply the scoring mechanism to rank and select an optimized efficient and reliable tool of the one or more tools for each operation associated with the one or more development operation tasks. The scoring mechanism is a method for computing a numerical score for each tool based on weighted evaluation of its metadata, performance characteristics, and historical performance data. The scoring mechanism enables objective comparison and ranking of multiple tools to identify the most suitable option for a given task. For example, a scoring mechanism may assign weights of 40% to reliability, 30% to latency, and 30% to domain applicability, then calculate a composite score for each candidate tool, selecting the tool with the highest score for execution.

In an embodiment, the action orchestrating subsystem 212 is configured to: (a) monitor a progress of each development operation task of the one or more development operation tasks in real-time; (b) determine whether the one or more development operation tasks fail during execution of the one or more development operation tasks; (c) upon detection of a failure during the execution of the one or more development operation tasks, reattempt the failed one or more development operation tasks automatically using one or more retry mechanisms, for mitigating disruption in an action workflow; and (d) manage at least one of: tool failures and process failures using one or more fallback mechanisms. The one or more fallback mechanisms are configured to at least one of: switch to one or more alternative tools and flag an issue for manual intervention.

The action orchestrating subsystem 212 ensures that each DevOps task of the one or more DevOps tasks is carried out in the correct order, as specified by the reasoning orchestrating subsystem 210, while also monitoring the progress of each DevOps task in real-time. The real-time monitoring is the continuous observation and tracking of the one or more development operation tasks as they execute, providing immediate visibility into the current state and progress of each task. The real-time monitoring enables the action orchestrating subsystem 212 to detect issues promptly and respond without delay. For example, during a multi-step deployment process, real-time monitoring tracks which steps have completed, which are in progress, and how long each step is taking compared to expected durations.

The failure detection is the process of determining when a development operation task does not complete successfully or encounters an error during execution. The failure detection may involve checking return codes, analyzing error messages, monitoring timeout conditions, or validating expected outputs. For example, if a task to create a virtual machine returns an error indicating insufficient resources, the system detects this as a failure and triggers appropriate response actions. The retry mechanisms are automated processes that reattempt failed development operation tasks without requiring manual intervention, with the goal of overcoming transient errors or temporary conditions that caused the initial failure. The retry mechanisms may incorporate configurable parameters such as the number of retry attempts, delay intervals between attempts, and exponential backoff strategies. For example, if a network request fails due to a temporary connectivity issue, the retry mechanism may wait a few seconds and attempt the request again, potentially succeeding on the subsequent attempt.

The action workflow is the sequence of interconnected actions and tasks that together accomplish a development operation objective, where each action may depend on or influence subsequent actions. Disruption to an action workflow occurs when a failure interrupts the normal progression of tasks. For example, an action workflow for database migration may include steps for backup, schema update, data transfer, and verification, where a failure in any step could disrupt the entire workflow.

The tool failures are situations where a specific tool invoked by the system fails to perform its intended function, whether due to software bugs, resource limitations, compatibility issues, or external service unavailability. For example, a tool failure may occur when a container image build tool crashes due to insufficient memory allocation. The process failures are situations where the overall execution process encounters problems that prevent successful completion, which may include issues beyond individual tool failures such as orchestration errors, communication breakdowns, or environmental problems. For example, a process failure may occur when the AI-based system 102 loses connectivity to a target server during a configuration update operation.

The fallback mechanisms are contingency procedures that the system employs when primary tools or processes fail, providing alternative paths to accomplish the intended task or escalate the issue appropriately. The fallback mechanisms enhance system resilience by ensuring that failures do not necessarily result in complete task abandonment. For example, if a primary cloud storage service is unavailable, a fallback mechanism may switch to an alternative storage provider to continue the backup operation, or if no alternative is available, the mechanism may flag the issue for manual intervention by notifying an administrator to resolve the problem.

The action orchestrating subsystem 212 increases the reliability of one or more dynamic computing environments (hybrid and multi-cloud environments, Infrastructure as Code (IaC), application Infrastructures, and cloud infrastructures) and ensures the one or more actions may not be interrupted by minor tool failures. Once the one or more DevOps tasks are completed, the action orchestrating subsystem 212 notifies the reasoning orchestrating subsystem 210, thereby keeping the workflow seamless and ensuring that subsequent one or more DevOps tasks proceed without delay.

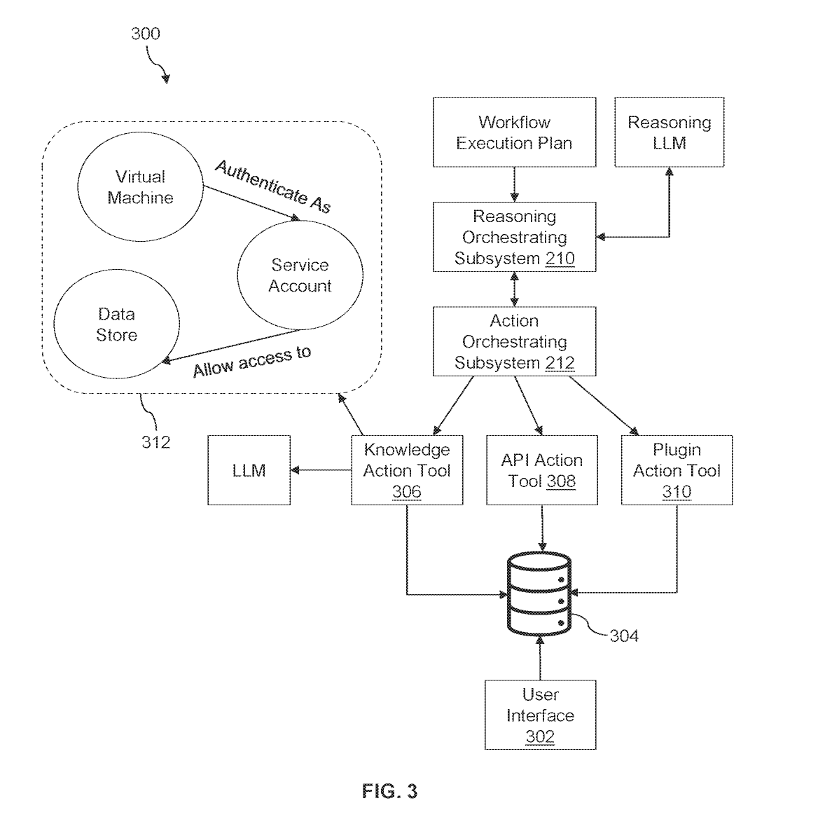

The plurality of tools may include, but not constrained to, at least one of: a knowledge action tool, an Application Programming Interface (API), a plugin action tool, and the like. In an embodiment, for selecting the one or more tools, the action orchestrating subsystem 212 is configured to select a knowledge action tool that is configured to maintain an adaptive and real-time map of one or more resources, dependencies, and configurations, within the one or more dynamic computing environments. The knowledge action tool processes the one or more actions related to the one or more adaptive knowledge graphs (as shown in FIG. 3). The knowledge action tool is configured to visualize intricate interrelationships between the one or more resources and provide a comprehensive view of how one or more components of the one or more dynamic computing environments depend on each other for real-time analysis and impact assessment.

The knowledge action tool is a specialized tool that creates and maintains a dynamic representation of all resources, their relationships, and configurations within the one or more dynamic computing environments. The knowledge action tool continuously updates this representation as changes occur, enabling the system to understand how different components are connected and how changes to one component may affect others. The knowledge action tool may store information in one or more adaptive knowledge graphs, which are data structures that represent entities as nodes and relationships as edges, allowing for efficient traversal and querying of complex interdependencies. For example, a knowledge action tool may maintain a map showing that a web application depends on a load balancer, which in turn depends on multiple server instances, and each server instance depends on specific network configurations and storage volumes, enabling the action orchestrating subsystem 212 to assess that taking down a particular server would affect the load balancer's capacity and potentially impact the web application's availability.

The adaptive and real-time map is a continuously updated representation of resources and their relationships that reflects the current state of the computing environment at any given moment. The adaptive and real-time map adapts automatically as resources are added, removed, or modified, ensuring that the action orchestrating subsystem 212 always has accurate information for decision-making. For example, when a new database replica is provisioned, the adaptive map automatically updates to include the new resource and its connections to the primary database and dependent applications.

The impact assessment is the process of evaluating how a proposed change or detected failure would affect other components within the computing environment by analyzing the dependencies and relationships captured in the knowledge map. The impact assessment helps prevent unintended consequences by identifying all resources that may be affected before changes are implemented. For example, before decommissioning a storage volume, impact assessment may reveal that three applications and two backup processes depend on that volume, allowing administrators to plan appropriate migrations.

For selecting the one or more tools, the action orchestrating subsystem 212 is further configured to select an application programming interface (API) action tool that is configured to facilitate one or more external API calls. The application programming interface (API) action tool is a tool that enables the action orchestrating subsystem 212 to communicate with external services and platforms by making API calls over network protocols. The API action tool handles the construction of requests, authentication, transmission, and processing of responses from external systems. For example, an API action tool may call a cloud provider's API to retrieve current pricing information, send notifications through an email service API, or query a third-party security scanning service for vulnerability reports.

For selecting the one or more tools, the action orchestrating subsystem 212 is further configured to select a plugin action tool that is configured to run one or more internal tools for the one or more dynamic computing tasks. The plugin action tool is a tool that executes internal utilities, scripts, or specialized modules that extend the system's capabilities for performing specific development operation tasks. The plugin action tools run within the system's environment and may be developed internally or obtained from trusted sources to address particular operational needs. The plugins provide modularity, allowing new functionality to be added without modifying the core system. For example, a plugin action tool may run a Monte Carlo simulation to estimate project risks, execute a script to scan code repositories for exposed credentials, or perform custom log analysis to identify anomalous patterns in system behavior.

In an embodiment, the action orchestrating subsystem 212 is configured to assess potential impact of changes and failures within the one or more dynamic computing environments, by employing one or more adaptive knowledge graphs. the action orchestrating subsystem 212 with the knowledge action tool is further configured to process the one or more natural language instructions related to resource dependencies and configurations for retrieving one or more related resources and analyzing a current state of the one or more dynamic computing environments. For instance, if a user of the one or more users requests information on a specific resource, the knowledge action tool may identify and provide details about all dependent resources and highlight configuration issues that may arise due to the changes in the specific resource.

The one or more adaptive knowledge graphs are dynamic data structures that represent resources, configurations, and their interrelationships as interconnected nodes and edges, continuously updating to reflect changes in the computing environment. Unlike static representations, the one or more adaptive knowledge graphs evolve in real-time as resources are provisioned, modified, or decommissioned, ensuring the action

orchestrating subsystem 212 maintains an accurate understanding of the current environment state. For example, an adaptive knowledge graph may represent a microservices architecture where each service is a node, and edges indicate communication pathways, data flows, and dependencies between services, automatically updating when a new service is deployed or an existing connection is modified.

The potential impact of changes and failures refers to the anticipated effects that modifications or disruptions to one resource may have on other connected resources within the computing environment. By traversing the adaptive knowledge graphs, the action orchestrating subsystem 212 can identify all downstream and upstream resources that would be affected by a change or failure. For example, if a user plans to update a shared authentication service, the system can assess that fifteen applications depend on this service and would experience authentication failures during the update window.

The resource dependencies are relationships where one resource requires another resource to function correctly, creating chains of reliance throughout the computing environment. Understanding resource dependencies is essential for planning changes, troubleshooting issues, and ensuring system stability. For example, a web application may have resource dependencies on a database server, a caching layer, and an external payment gateway, meaning disruption to any of these resources would affect the application's functionality. The current state refers to the present configuration, status, and operational condition of all resources within the computing environment at a specific point in time. Analyzing the current state enables the action orchestrating subsystem 212 to make informed decisions based on actual conditions rather than outdated or assumed information. For example, before executing a scaling operation, the action orchestrating subsystem 212 analyzes the current state to determine existing instance counts, resource utilization levels, and active connections, ensuring the scaling action is appropriate for present conditions.

The plurality of subsystems 110 further includes the report generating subsystem 214 that is communicatively connected to the one or more hardware processors 106. The report generating subsystem 214 is configured to generate one or more comprehensive reports associated with the execution of the one or more development operation tasks, along with orchestration results, thereby assisting the one or more users in tracking progress and outcomes. The comprehensive report is displayed on the user interface that visualizes the one or more actions performed during the execution of the one or more DevOps tasks, providing the one or more users with a transparent view of at least one of: completed one or more DevOps tasks, the status, and the resulting outcomes. In addition, the report generating subsystem 214 may simulate potential risks and identify bottlenecks, such as configuration drift, that may impact the performance of the one or more dynamic computing environments. For instance, if a security breach simulation is performed, the report generating subsystem 214 may generate the comprehensive report that outlines the costs of the simulated breach, assesses the potential impact, and provides recommendations for mitigating such risks. This reporting functionality enables the one or more users to make informed decisions, optimize the one or more DevOps tasks, and ensure the reliability of the one or more dynamic computing environments over time.

The plurality of subsystems 110 further includes the output subsystem 216 that is communicatively connected to the one or more hardware processors 106. The output subsystem 216 is configured to automatically provide the generated one or more comprehensive reports with the orchestration results, as the output, to the one or more users through the one or more user interfaces associated with the one or more electronic devices 114 of the one or more users. The output subsystem 216 is a component of the AI-based system 102 responsible for delivering the generated comprehensive reports and orchestration results to the one or more users in a presentable and accessible format. The output subsystem 216 handles the formatting, transmission, and display of information to ensure the one or more users receive timely and understandable feedback about the executed development operation tasks. For example, after a deployment task completes, the output subsystem 216 formats the results into a readable report and sends it to the user's dashboard.

The one or more comprehensive reports are detailed documents that summarize the execution of development operation tasks, including information about which tasks were performed, the sequence of actions taken, the outcomes of each action, any errors encountered, and recommendations for future actions. The one or more comprehensive reports provide users with complete visibility into what the system accomplished on their behalf. For example, a comprehensive report for a security audit task may include a list of scanned resources, identified vulnerabilities, severity ratings, and suggested remediation steps. The orchestration results are the outcomes and outputs produced by the execution of the development operation tasks as coordinated by the action orchestrating subsystem 212. The orchestration results may include success or failure status, performance metrics, generated artifacts, log entries, and any data produced during task execution. For example, The orchestration results for a database backup task may include the backup file location, file size, duration of the backup process, and verification checksum.

The one or more user interfaces are the visual or interactive surfaces through which users interact with the system and receive information. The one or more user interfaces may include graphical dashboards, web portals, command-line interfaces, mobile applications, or notification systems that display reports and results in a user-friendly manner. For example, a user interface may present orchestration results as a visual timeline showing completed tasks with green indicators and failed tasks with red indicators.

FIG. 3 illustrates an exemplary flow diagram representation 300 of the AI-based system 102 for automatically orchestrating the one or more development operation tasks within the one or more dynamic computing environments, using the action registry, in accordance with an embodiment of the present disclosure.

The reasoning orchestrating subsystem 210 is configured to generate the one or more execution plans by analyzing the objective data using the reasoning large language model (LLM). The action orchestrating subsystem 212 is configured to generate the one or more actions for executing the one or more development operation tasks that are outlined in the execution plan provided by the reasoning orchestrating subsystem 210. The action orchestrating subsystem 212 ensures that each DevOps task is carried out in the correct order while also monitoring the progress of each DevOps task in real-time.

This action registry is configured to manage the one or more tools, ranging from internal utilities to external services, that may be utilized to carry out specific operations defined in the execution plan. The knowledge action tool 306 that processes the one or more actions related to the one or more adaptive knowledge graphs 312. The knowledge action tool 306 maintains an adaptive and real-time map of all resources, the dependencies, and configurations within the one or more dynamic computing environments. The knowledge action tool 306 visualizes the intricate interrelationships between different resources, thereby providing a comprehensive view of how components of the one or more dynamic computing environments depend on one another, which is essential for real-time analysis and impact assessment. The one or more adaptive knowledge graphs 312 are data structures that enable the system to assess the potential impact of changes and failures. The knowledge action tool 306 processes the one or more instructions related to resource dependencies and configurations for retrieving related resources and analyzing the current state of the one or more dynamic computing environments.

The API action tool 308 is configured to facilitate external API calls such as sending emails and interacting with third-party services. The plugin action tool 310 is configured to run internal tools for the one or more DevOps tasks such as running simulations and scanning data for sensitive information. The logs associated with one or more actions for the execution of the one or more development operation tasks is stored in action log database 304, and the one or more users may have access for the logs through the one or more user interfaces 302.

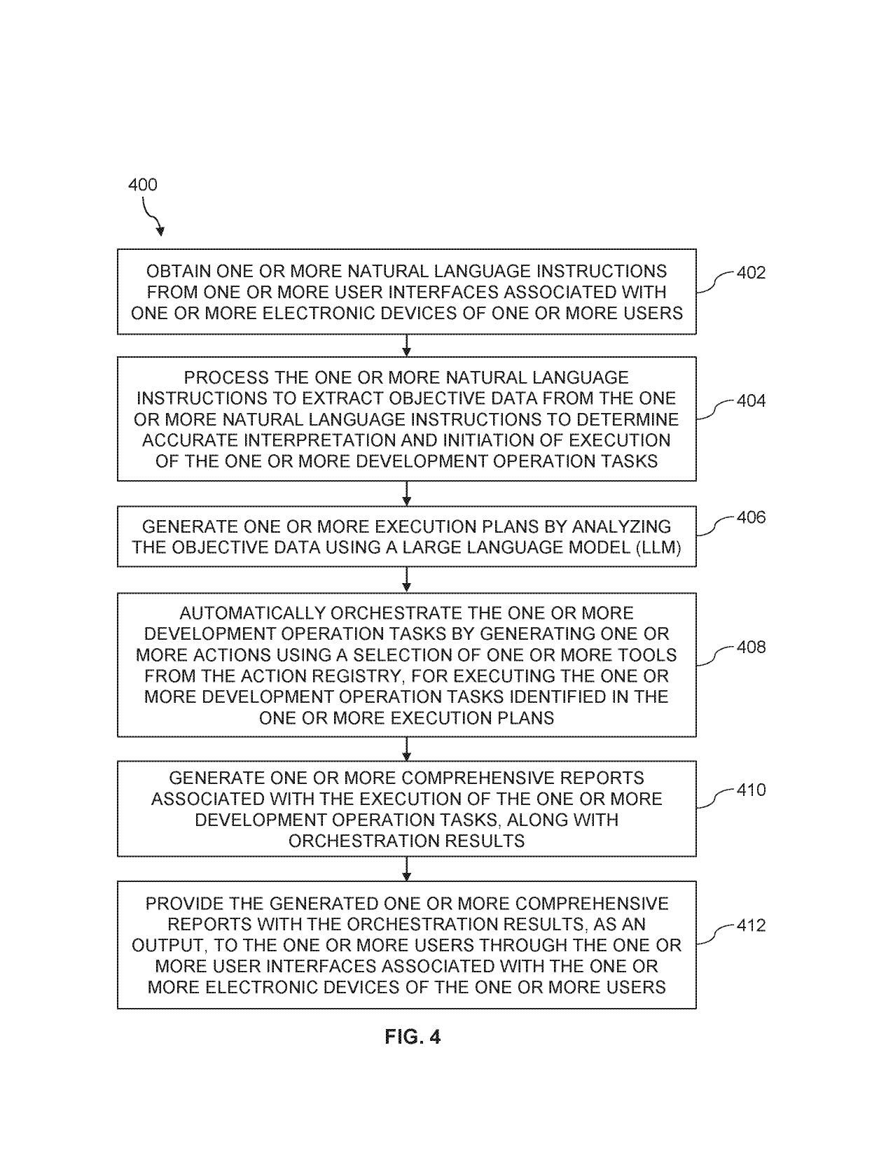

FIG. 4 is a flow chart illustrating an AI-based method 400 for automatically orchestrating the one or more development operation tasks within the one or more dynamic computing environments, using the action registry, in accordance with an embodiment of the present disclosure.

At step 402, the one or more natural language instructions are obtained from the one or more user interfaces associated with the one or more electronic devices 114 of the one or more users.

At step 404, the one or more natural language instructions are processed to extract objective data from the one or more natural language instructions to determine the accurate interpretation and initiation of execution of the one or more development operation tasks. The objective data comprises at least one of: the one or more objectives, the one or more circumstances, and the one or more parameters and constraints.

At step 406, the one or more execution plans are generated by analyzing the objective data using the large language model (LLM).

At step 408, the one or more development operation tasks are automatically orchestrated by generating the one or more actions using a selection of the one or more tools from the action registry, for executing the one or more development operation tasks identified in the one or more execution plans.

At step 410, the one or more comprehensive reports associated with the execution of the one or more development operation tasks, are generated along with orchestration results.

At step 412, the generated one or more comprehensive reports with the orchestration results are provided as the output, to the one or more users through the one or more user interfaces associated with the one or more electronic devices 114 of the one or more users.

Numerous advantages of the present disclosure may be apparent from the discussion above. In accordance with the present disclosure, the present invention with the AI-based system 102 is configured to perform the one or more actions on the one or more adaptive knowledge graphs 312 with infrastructure provisioning and DevOps optimization is disclosed. The AI-based system 102 is configured to track and evaluate tool performance over time, thereby adjusting the recommendations dynamically based on historical success rates.

The AI-based system 102 is configured to improve accuracy and efficiency over time by leveraging the historical performance data. The AI-based system 102 is configured with a Role-based access control (RBAC) and logging for all tool invocations. Additionally, the AI-based system 102 is configured to perform real-time security checks when executing the one or more DevOps tasks. The AI-based system 102 is configured to enhance trust and complies with regulatory and security standards.

The AI-based system 102 is configured to integrate the one or more reasoning LLMs for advanced decision-making, enabling context-aware task execution and workflow optimization. The AI-based system 102 is configured to simulate the impact of dynamic computing environment changes to predict and mitigate risks before implementation. The AI-based system 102 is configured to identify underutilized resources, thereby providing recommendations to reduce operational expenses and optimize provisioning.

The AI-based system 102 is configured to support the hybrid and multi-cloud environments (e.g., Amazon Web Services^{®} (AWS^{®}), Google Cloud Platform^{®} (GCP^{®}), and Azure^{®}) associated with the one or more dynamic cloud environments, thereby eliminating the need for platform-specific tools. The AI-based system 102 is configured with a cloud-agnostic architecture for supporting hybrid and multi-cloud environment migration and provisioning. The AI-based system 102 is configured to dynamically update and visualize the cloud infrastructures and the application infrastructures as the one or more adaptive knowledge graphs 312.

The AI-based system 102 is configured to reduce downtime by predicting and mitigating potential bottlenecks and misconfigurations. The AI-based system 102 is configured to

employ the one or more reasoning LLMs to analyze contexts and suggest optimal solutions for DevOps operations. Advanced features such as context awareness, prioritized tool selection, predefined templates, the one or more fallback mechanisms, and integration with external data sources enhance the reliability, scalability, and adaptability of the one or more dynamic computing environments.

The AI-based system 102 is configured to at least one of: (a) enhance speed and accuracy in provisioning cloud resources, (b) improve deployment workflows with simulation and dependency analysis, (c) provide unified visibility and control over the hybrid and multi-cloud environments, (d) identify redundant resources and underutilized resources to reduce the costs, (e) map critical dependencies for reliable recovery during outages, and (f) serve as a shared source of truth to enhance teamwork and reduce operational silos.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the AI-based system 102 either directly or through intervening I/O controllers. Network adapters may also be coupled to the AI-based system 102 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/AI-based system 102 in accordance with the embodiments herein. The AI-based system 102 herein comprises at least one processor or central processing unit (CPU). The CPUs are interconnected via the system bus 202 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the AI-based system 102. The AI-based system 102 can read the inventive instructions on the program storage devices and follow these instructions to execute the methodology of the embodiments herein.

The AI-based system 102 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words "comprising", "having", "containing", and "including", and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a”, “an”, and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. An artificial intelligence (AI) based method for automatically orchestrating one or more development operation tasks within one or more dynamic computing environments, using an action registry, the AI-based method comprising:
obtaining, by one or more hardware processors, one or more natural language instructions from one or more user interfaces associated with one or more electronic devices of one or more users;
processing, by the one or more hardware processors, the one or more natural language instructions to extract objective data from the one or more natural language instructions to determine accurate interpretation and initiation of execution of the one or more development operation tasks, wherein the objective data comprises at least one of: one or more objectives, one or more circumstances, and one or more parameters and constraints;
generating, by the one or more hardware processors, one or more execution plans by analyzing the objective data using a large language model (LLM);
automatically orchestrating, by the one or more hardware processors, the one or more development operation tasks by generating one or more actions using a selection of one or more tools from the action registry, for executing the one or more development operation tasks identified in the one or more execution plans;
generating, by the one or more hardware processors, one or more comprehensive reports associated with the execution of the one or more development operation tasks, along with orchestration results; and
providing, by the one or more hardware processors, the generated one or more comprehensive reports with the orchestration results, as an output, to the one or more users through the one or more user interfaces associated with the one or more electronic devices of the one or more users.

2. The AI-based method of claim 1, wherein processing the one or more natural language instructions to extract the objective data comprises:
translating, by the one or more hardware processors, the one or more natural language instructions into one or more actionable workflows for orchestration of the one or more development operation tasks;
identifying, by the one or more hardware processors, the one or more objectives from the one or more natural language instructions, wherein the one or more objectives comprise at least one of: simulation, optimization, and monitoring, of the one or more development operation tasks performed within the one or more dynamic computing environments;
identifying, by the one or more hardware processors, the one or more circumstances from the one or more natural language instructions, wherein the one or more circumstances comprise infrastructure and environment related to a development operation task of the one or more development operation tasks; and
identifying, by the one or more hardware processors, the one or more parameters and constraints from the one or more natural language instructions, wherein the one or more parameters and constraints comprise at least one of: timeframes, budgets, and specific tools, for execution of the one or more development operation tasks;
wherein the extracted objective data forms a semantic blueprint that defines the one or more development operation tasks and conditions required for execution of the one or more development operation tasks.

3. The AI-based method of claim 1, wherein generating the one or more execution plans by analyzing the objective data using the LLM, comprises:
generating, by the one or more hardware processors, a structured framework detailing the one or more development operation tasks, wherein the structured framework comprises one or more action workflows in one or more structured formats;
determining, by the one or more hardware processors, one or more dependencies between the one or more development operation tasks;
utilizing, by the one or more hardware processors, topological sorting technique to prioritize the one or more development operation tasks based on the one or more dependencies;
determining, by the one or more hardware processors, one or more steps required to achieve one or more results associated with the execution of the one or more development operation tasks; and
dynamically adapting, by the one or more hardware processors, each step of the one or more steps to real-time conditions using a feedback loop and multi-turn reasoning to refine an approach during execution of the one or more development operation tasks, for determining accuracy and reliability for complex one or more development operation tasks.

4. The AI-based method of claim 1, wherein selecting the one or more tools from the action registry for executing the one or more development operation tasks with the orchestration results, comprises:
accessing, by the one or more hardware processors, the action registry to retrieve one or more tools, wherein the action registry acts as a centralized repository that stores the one or more tools and functionalities required for executing the one or more development operation tasks within the one or more dynamic computing environments;
retrieving, by the one or more hardware processors, metadata associated with each tool of the one or more tools, wherein the metadata comprises at least one of: reliability, latency, and domain applicability, corresponding to each tool of the one or more tools;
assessing, by the one or more hardware processors, performance characteristics and suitability of the one or more tools for the one or more development operation tasks based on the retrieved metadata associated with each tool of the one or more tools;
analyzing, by the one or more hardware processors, historical performance data to learn from past tool performance and success rates associated with the execution of the one or more development operation tasks with the orchestration results, for adapting the one or more tools to changes in requirements of the one or more dynamic computing environments and resource constraints; and
applying, by the one or more hardware processors, a scoring mechanism to rank and select an optimized efficient and reliable tool of the one or more tools for each operation associated with the one or more development operation tasks.

5. The AI-based method of claim 1, wherein selecting the one or more tools comprises at least one of:
selecting, by the one or more hardware processors, a knowledge action tool that is configured to maintain an adaptive and real-time map of one or more resources, dependencies, and configurations, within the one or more dynamic computing environments, wherein the knowledge action tool is configured to visualize intricate interrelationships between the one or more resources and provide a comprehensive view of how one or more components of the one or more dynamic computing environments depend on each other for real-time analysis and impact assessment;
selecting, by the one or more hardware processors, an application programming interface (API) action tool that is configured to facilitate one or more external API calls; and
selecting, by the one or more hardware processors, a plugin action tool that is configured to run one or more internal tools for the one or more dynamic computing tasks.

6. The AI-based method of claim 5, further comprising performing, by the one or more hardware processors, one or more operations using the knowledge action tool, comprises:
assessing, by the one or more hardware processors, potential impact of changes and failures within the one or more dynamic computing environments, by employing one or more adaptive knowledge graphs; and
processing, by the one or more hardware processors, the one or more natural language instructions related to resource dependencies and configurations for retrieving one or more related resources and analyzing a current state of the one or more dynamic computing environments.

7. The AI-based method of claim 1, further comprising:
monitoring, by the one or more hardware processors, a progress of each development operation task of the one or more development operation tasks in real-time;
determining, by the one or more hardware processors, whether the one or more development operation tasks fail during execution of the one or more development operation tasks;
upon detection of a failure during the execution of the one or more development operation tasks, reattempting, by the one or more hardware processors, the failed one or more development operation tasks automatically using one or more retry mechanisms, for mitigating disruption in an action workflow; and
managing, by the one or more hardware processors, at least one of: tool failures and process failures using one or more fallback mechanisms, wherein the one or more fallback mechanisms are configured to at least one of: switch to one or more alternative tools and flag an issue for manual intervention.

8. An artificial intelligence based (AI-based) system for automatically orchestrating one or more development operation tasks within one or more dynamic computing environments, using an action registry, the AI-based system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
an instruction obtaining subsystem configured to obtain one or more natural language instructions from one or more user interfaces associated with one or more electronic devices of one or more users;
an instruction processing generating subsystem configured to process the one or more natural language instructions to extract objective data from the one or more natural language instructions to determine accurate interpretation and initiation of execution of the one or more development operation tasks, wherein the objective data comprises at least one of: one or more objectives, one or more circumstances, and one or more parameters and constraints;
a reasoning orchestrating generating subsystem configured to generate one or more execution plans by analyzing the objective data using a large language model (LLM);
an action orchestrating subsystem configured to automatically orchestrate the one or more development operation tasks by generating one or more actions using a selection of one or more tools from the action registry, for executing the one or more development operation tasks identified in the one or more execution plans;
a report generating subsystem configured to generate one or more comprehensive reports associated with the execution of the one or more development operation tasks, along with orchestration results; and
an output subsystem configured to automatically provide the generated one or more comprehensive reports with the orchestration results, as an output, to the one or more users through the one or more user interfaces associated with the one or more electronic devices of the one or more users.

9. The AI-based system of claim 8, wherein in processing the one or more natural language instructions to extract the objective data, the instruction processing subsystem is further configured to:
translate the one or more natural language instructions into one or more actionable workflows for orchestration of the one or more development operation tasks;
identify the one or more objectives from the one or more natural language instructions, wherein the one or more objectives comprise at least one of: simulation, optimization, and monitoring, of the one or more development operation tasks performed within the one or more dynamic computing environments;
identify the one or more circumstances from the one or more natural language instructions, wherein the one or more circumstances comprise infrastructure and environment related to a development operation task of the one or more development operation tasks; and
identify the one or more parameters and constraints from the one or more natural language instructions, wherein the one or more parameters and constraints comprise at least one of: timeframes, budgets, and specific tools, for execution of the one or more development operation tasks;
wherein the extracted objective data forms a semantic blueprint that defines the one or more development operation tasks and conditions required for execution of the one or more development operation tasks.

10. The AI-based system of claim 8, wherein in generating the one or more execution plans by analyzing the objective data using the LLM, the reasoning orchestrating subsystem is further configured to:
generate a structured framework detailing the one or more development operation tasks, wherein the structured framework comprises one or more action workflows in one or more structured formats;
determine one or more dependencies between the one or more development operation tasks;
utilize topological sorting technique to prioritize the one or more development operation tasks based on the one or more dependencies;
determine one or more steps required to achieve one or more results associated with the execution of the one or more development operation tasks; and
dynamically adapt each step of the one or more steps to real-time conditions using a feedback loop and multi-turn reasoning to refine an approach during execution of the one or more development operation tasks, for determining accuracy and reliability for complex one or more development operation tasks.

11. The AI-based system of claim 8, wherein in selecting the one or more tools from the action registry for executing the one or more development operation tasks with the orchestration results, the action orchestrating subsystem is further configured to:
access the action registry to retrieve one or more tools, wherein the action registry acts as a centralized repository that stores the one or more tools and functionalities required for executing the one or more development operation tasks within the one or more dynamic computing environments;
retrieve metadata associated with each tool of the one or more tools, wherein the metadata comprises at least one of: reliability, latency, and domain applicability, corresponding to each tool of the one or more tools;
assess performance characteristics and suitability of the one or more tools for the one or more development operation tasks based on the retrieved metadata associated with each tool of the one or more tools;
analyze historical performance data to learn from past tool performance and success rates associated with the execution of the one or more development operation tasks with the orchestration results, for adapting the one or more tools to changes in requirements of the one or more dynamic computing environments and resource constraints; and
apply a scoring mechanism to rank and select an optimized efficient and reliable tool of the one or more tools for each operation associated with the one or more development operation tasks.

12. The AI-based system of claim 8, wherein in selecting the one or more tools, the action orchestrating subsystem is configured to at least one of:
select a knowledge action tool that is configured to maintain an adaptive and real-time map of one or more resources, dependencies, and configurations, within the one or more dynamic computing environments, wherein the knowledge action tool is configured to visualize intricate interrelationships between the one or more resources and provide a comprehensive view of how one or more components of the one or more dynamic computing environments depend on each other for real-time analysis and impact assessment;
select an application programming interface (API) action tool that is configured to facilitate one or more external API calls; and
select a plugin action tool that is configured to run one or more internal tools for the one or more dynamic computing tasks.

13. The AI-based system of claim 12, wherein the action orchestrating subsystem is further configured to:
assess potential impact of changes and failures within the one or more dynamic computing environments, by employing one or more adaptive knowledge graphs; and
process the one or more natural language instructions related to resource dependencies and configurations for retrieving one or more related resources and analyzing a current state of the one or more dynamic computing environments.

14. The AI-based system of claim 8, wherein the action orchestrating subsystem is further configured to:
monitor a progress of each development operation task of the one or more development operation tasks in real-time;
determine whether the one or more development operation tasks fail during execution of the one or more development operation tasks;
upon detection of a failure during the execution of the one or more development operation tasks, reattempt the failed one or more development operation tasks automatically using one or more retry mechanisms, for mitigating disruption in an action workflow; and
manage at least one of: tool failures and process failures using one or more fallback mechanisms, wherein the one or more fallback mechanisms are configured to at least one of: switch to one or more alternative tools and flag an issue for manual intervention.

15. A non-transitory computer-readable storage medium having instructions stored therein that when executed by one or more hardware processors, cause the one or more hardware processors to execute operations of:
obtaining one or more natural language instructions from one or more user interfaces associated with one or more electronic devices of one or more users;
processing the one or more natural language instructions to extract objective data from the one or more natural language instructions to determine accurate interpretation and initiation of execution of one or more development operation tasks, wherein the objective data comprises at least one of: one or more objectives, one or more circumstances, and one or more parameters and constraints;
generating one or more execution plans by analyzing the objective data using a large language model (LLM);
automatically orchestrating the one or more development operation tasks by generating one or more actions using a selection of one or more tools from the action registry, for executing the one or more development operation tasks identified in the one or more execution plans;
generating one or more comprehensive reports associated with the execution of the one or more development operation tasks, along with orchestration results; and
providing the generated one or more comprehensive reports with the orchestration results, as an output, to the one or more users through the one or more user interfaces associated with the one or more electronic devices of the one or more users.

16. The non-transitory computer-readable storage medium of claim 15, wherein processing the one or more natural language instructions to extract the objective data comprises:
translating the one or more natural language instructions into one or more actionable workflows for orchestration of the one or more development operation tasks;
identifying the one or more objectives from the one or more natural language instructions, wherein the one or more objectives comprise at least one of: simulation, optimization, and monitoring, of the one or more development operation tasks performed within one or more dynamic computing environments;
identifying the one or more circumstances from the one or more natural language instructions, wherein the one or more circumstances comprise infrastructure and environment related to a development operation task of the one or more development operation tasks; and
identifying the one or more parameters and constraints from the one or more natural language instructions, wherein the one or more parameters and constraints comprise at least one of: timeframes, budgets, and specific tools, for execution of the one or more development operation tasks;
wherein the extracted objective data forms a semantic blueprint that defines the one or more development operation tasks and conditions required for execution of the one or more development operation tasks.

17. The non-transitory computer-readable storage medium of claim 15, wherein generating the one or more execution plans by analyzing the objective data using the LLM, comprises:
generating a structured framework detailing the one or more development operation tasks, wherein the structured framework comprises one or more action workflows in one or more structured formats;
determining one or more dependencies between the one or more development operation tasks;
utilizing topological sorting technique to prioritize the one or more development operation tasks based on the one or more dependencies;
determining one or more steps required to achieve one or more results associated with the execution of the one or more development operation tasks; and
dynamically adapting each step of the one or more steps to real-time conditions using a feedback loop and multi-turn reasoning to refine an approach during execution of the one or more development operation tasks, for determining accuracy and reliability for complex one or more development operation tasks.

18. The non-transitory computer-readable storage medium of claim 15, wherein selecting the one or more tools from the action registry for executing the one or more development operation tasks with the orchestration results, comprises:
accessing the action registry to retrieve one or more tools, wherein the action registry acts as a centralized repository that stores the one or more tools and functionalities required for executing the one or more development operation tasks within the one or more dynamic computing environments;
retrieving metadata associated with each tool of the one or more tools, wherein the metadata comprises at least one of: reliability, latency, and domain applicability, corresponding to each tool of the one or more tools;
assessing performance characteristics and suitability of the one or more tools for the one or more development operation tasks based on the retrieved metadata associated with each tool of the one or more tools;
analyzing historical performance data to learn from past tool performance and success rates associated with the execution of the one or more development operation tasks with the orchestration results, for adapting the one or more tools to changes in requirements of the one or more dynamic computing environments and resource constraints; and
applying a scoring mechanism to rank and select an optimized efficient and reliable tool of the one or more tools for each operation associated with the one or more development operation tasks.

19. The non-transitory computer-readable storage medium of claim 15, wherein selecting the one or more tools comprises at least one of:
selecting a knowledge action tool that is configured to maintain an adaptive and real-time map of one or more resources, dependencies, and configurations, within the one or more dynamic computing environments, wherein the knowledge action tool is configured to visualize intricate interrelationships between the one or more resources and provide a comprehensive view of how one or more components of the one or more dynamic computing environments depend on each other for real-time analysis and impact assessment, and wherein the knowledge action tool is further configured to:
assess potential impact of changes and failures within the one or more dynamic computing environments, by employing one or more adaptive knowledge graphs; and
process the one or more natural language instructions related to resource dependencies and configurations for retrieving one or more related resources and analyzing a current state of the one or more dynamic computing environments;
selecting an application programming interface (API) action tool that is configured to facilitate one or more external API calls; and
selecting a plugin action tool that is configured to run one or more internal tools for the one or more dynamic computing tasks.

20. The non-transitory computer-readable storage medium of claim 15, further comprising:
monitoring a progress of each development operation task of the one or more development operation tasks in real-time;
determining whether the one or more development operation tasks fail during execution of the one or more development operation tasks;
upon detection of a failure during the execution of the one or more development operation tasks, reattempting the failed one or more development operation tasks automatically using one or more retry mechanisms, for mitigating disruption in an action workflow; and
managing at least one of: tool failures and process failures using one or more fallback mechanisms, wherein the one or more fallback mechanisms are configured to at least one of: switch to one or more alternative tools and flag an issue for manual intervention.
